(19) United States
(12) Patent Application Publication
(10) Pub. No.: US 2026/0212433 A1
(43) Pub. Date: Jul. 23, 2026

(54) Facility Data Management Using Generative Artificial Intelligence

(71) Applicant: Softbank Group Corp., Tokyo (JP)

(72) Inventor: Ko Chatani, Tokyo (JP)

(21) Appl. No.: 19/447,593

(22) Filed: Jan. 13, 2026

(30) Foreign Application Priority Data
Jan. 17, 2025 (JP) 2025-007181

(51) Int. Cl. G06Q 50/163

(52) U.S. Cl. CPC G06Q 50/163

(57) ABSTRACT

A data processing device may include: a structuring unit configured to input information for facility management of a building into generative AI to structure a storage location for document information about facilities of the building; an extraction processing unit configured to input the document information into the generative AI to extract facility information about the facilities and store the document information in the structured storage location; and/or an update management unit configured to input the facility information into the generative AI to generate notification information for performing notification regarding the facilities and manage execution of notification according to the notification information.

### CROSS REFERENCE TO RELATED APPLICATIONS

The present application claims priority from Japanese Patent Application No. 2025-007181, filed on January 17, 2025, the entire disclosure of which is incorporated herein by reference.

### BACKGROUND

### Technical Field

The technology of the present disclosure relates to a data processing device, a data processing method, and a program.

### Related Art

Japanese Patent Application Laid-Open (JP-A) No. 2024-157264 discloses a building facility control system capable of easily setting the control of multiple devices installed in a building in a collective manner. In JP-A No. 2024-157264, it is possible to specify and extract another building facility having the same attribute information as the building facility specified by the building facility ID.

### SUMMARY OF THE INVENTION

### Technical Problem

In large-scale buildings, various facilities such as security cameras, sensors, and smart locks may be used, but there is room for improvement in management of these facilities. For example, vendor-provided documentation describing specifications and the like of facilities may come in various formats, making it not easy to grasp usage methods and maintenance methods for various portions of those facilities. And, for example, if the number of facilities increases, it might not be easy to grasp maintenance times. In addition, if the documentation is stored in a location specified by a vendor, it may take time and effort to find information necessary for managing facilities, which makes management more complicated.

### Solution to Problem

A data processing device according to one or more aspects of the present disclosure may include: a structuring unit configured to input, into generative AI, information for facility management of a building to structure a storage location for document information about facilities of the building; an extraction processing unit configured to input, into the generative AI, the document information to extract facility information about the facilities and/or to store the document information in the structured storage location; and an update management unit configured to input, into the generative AI, the facility information to generate notification information for performing notification regarding the facilities and/or to manage execution of notification according to the notification information.

Aspects described herein additionally and/or alternatively relate to a data processing method. That data processing method may be executed by a computer according to the technology of the present disclosure and may include: inputting, into generative AI, information for facility management of a building to structure a storage location for document information about facilities of the building; inputting, into the generative AI, the document information to extract facility information about the facilities and/or to store the document information in the structured storage location; and inputting, into the generative AI, the facility information to generate notification information for performing notification regarding the facilities and/or to manage execution of notification according to the notification information.

Additionally and/or alternatively, aspects described herein may relate to a program. For example, one or more non-transitory computer-readable media may store instructions that, when execute, cause a computer to execute steps such as: inputting, into generative AI, information for facility management of a building to structure a storage location for document information about facilities of the building; inputting, into the generative AI, the document information to extract facility information about the facilities and/or to store the document information in the structured storage location; and inputting, into the generative AI, the facility information to generate notification information for performing notification regarding the facilities and/or to manage execution of notification according to the notification information.

### BRIEF DESCRIPTION OF THE DRAWINGS

FIG. 1 is a block diagram illustrating an example of a configuration of a data processing system;

FIG. 2 is a block diagram illustrating an example of functions of main parts of a data processing device;

FIG. 3 is a diagram illustrating an example of how to train a data generation model;

FIG. 4 is a diagram illustrating an example of notification management for facilities based on generated notification information;

FIG. 5 is a diagram illustrating an example of map information and list information about related facilities;

FIG. 6 is a flowchart for an example of how a structure of a storage location may be processed;

FIG. 7 is a flowchart for an example of how facility information may be extracted and how notification information may be generated;

FIG. 8 is a flowchart for an example of how information about reference facilities may be output; and

FIG. 9 is a flowchart for an example of how facility information may be updated.

### DETAILED DESCRIPTION OF THE INVENTION

Hereinafter, embodiments of a data processing device, a data processing method, and a program according to the technology of the present disclosure will be described with reference to the accompanying drawings.

First, words used in the following description will be described.

In the following examples, a processor to which a reference sign is attached (hereinafter, simply referred to as “processor”) may comprise one arithmetic device or a combination of a plurality of arithmetic devices. Additionally and/or alternatively, the processor may comprise one type of arithmetic device or a combination of a plurality of types of arithmetic devices. Examples of the arithmetic device include a central processing unit (CPU), a graphics processing unit (GPU), a general-purpose computing on graphics processing unit (GPGPU), an accelerated processing unit (APU), and the like.

In the following examples, a random-access memory (RAM) to which a reference sign is attached may comprise a memory in which information is temporarily stored. Such memory may be used as a work memory by the processor.

In the following examples, a storage to which a reference sign is attached may comprise one or more nonvolatile storage devices that store various programs, various parameters, and/or the like. Examples of the nonvolatile storage device include a flash memory (e.g. solid state drive (SSD)), a magnetic disk (e.g., a hard disk), and a magnetic tape.

In the following examples, a communication interface (I/F) to which a reference sign is attached may comprise an interface including one or more of: a communication processor, an antenna, etc. The communication I/F may manage communication between a plurality of computers. Examples of the communication standard applied to the communication I/F may include wireless communication standards including a 5th generation mobile communication system (5G), Wi-Fi (a registered trademark of the Wi-Fi Alliance of Austin, TX), and Bluetooth (a registered trademark of Bluetooth SIG, Inc. of Kirkland, WA).

In the following examples, “A and/or B” is synonymous with “at least one of A or B.” That is, “A and/or B” may mean only A, only B, or a combination of A and B. Furthermore, in the present specification, the same concept as “A and/or B” is applied also in a case where three or more things are expressed in a combined manner by “and/or”.

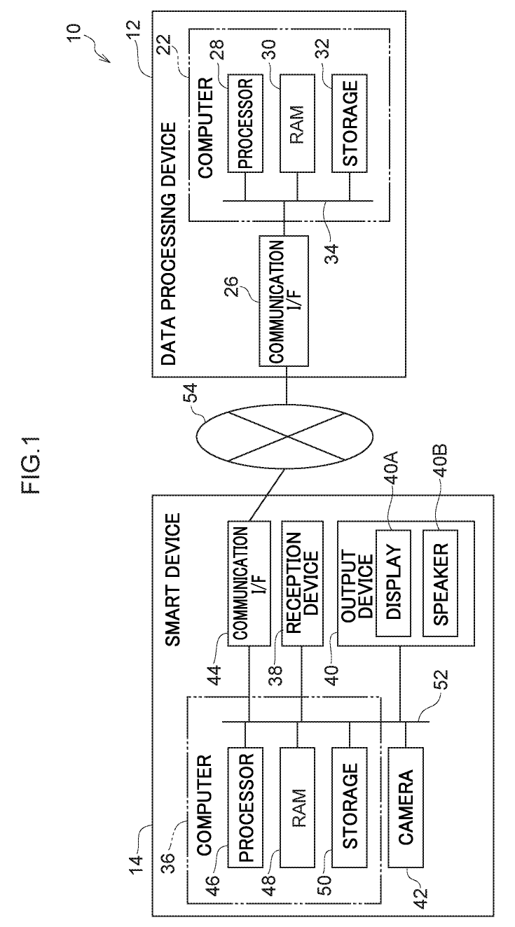

FIG. 1 illustrates an example of a configuration of a data processing system 10.

As illustrated in FIG. 1, the data processing system 10 is depicted by way of example as including a data processing device 12 and a smart device 14. Examples of the data processing device 12 include a server. Examples of the smart device 14 include a smartphone, a tablet terminal, smart glasses, a headset type terminal, a personal computer, and a robot. The smart device 14 may be used by a user who is a building administrator.

The data processing device 12 may include a computer 22 and a communication I/F 26. The computer 22 may be an example of a “computer” according to the technology of the present disclosure. The computer 22 may include a processor 28, a RAM 30, and a storage 32. The processor 28, the RAM 30, and the storage 32 may be connected to a bus 34. The communication I/F 26 might also connected to the bus 34. The communication I/F 26 may be connected to a network 54. Examples of the network 54 include a wide area network (WAN) and/or a local area network (LAN).

The smart device 14 may include a computer 36, a reception device 38, an output device 40, a camera 42, and/or a communication I/F 44. The computer 36 may include a processor 46, a RAM 48, and a storage 50. The processor 46, the RAM 48, and the storage 50 may be connected to a bus 52. The reception device 38, the output device 40, the camera 42, and/or the communication I/F 44 might also be connected to the bus 52.

The reception device 38 may receive a user input. Examples of the reception device 38 may include a touch panel, a microphone, a keyboard, and/or a mouse. The output device 40 may include a display 40A, a speaker 40B, and the like. The output device 40 may present data to the user by outputting the data in a user-perceptible expression (e.g., voice and/or text). The camera 42 may comprise a small digital camera on which an optical system including a lens, a diaphragm, a shutter, etc. and/or an imaging element such as a complementary metal-oxide-semiconductor (CMOS) image sensor or a charge coupled device (CCD) image sensor may be mounted.

The communication I/F 44 may be connected to the network 54. The communication I/Fs 44 and 26 might manage exchange of various types of information between the processor 46 and the processor 28 via the network 54.

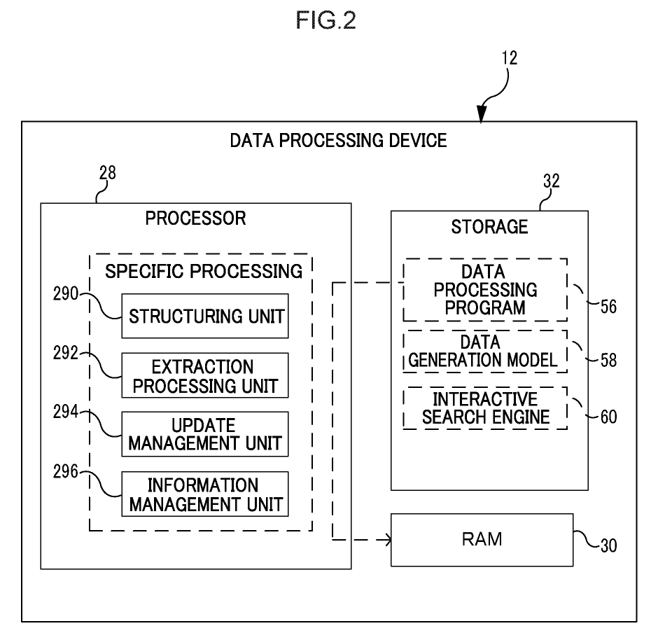

FIG. 2 illustrates an example of functions of main parts of the data processing device 12. As illustrated in FIG. 2, in the data processing device 12, specific processing may be performed by the processor 28 through various types of data processing. The storage 32 may store a data processing program 56. The processor 28 may read the data processing program 56 from the storage 32 and may execute the read data processing program 56 on the RAM 30. The specific processing may be realized by a structuring unit 290, an extraction processing unit 292, an update management unit 294, and/or an information management unit 296 operating according to the data processing program 56 executed by the processor 28 on the RAM 30.

The storage 32 may store a data generation model 58 and/or an interactive search engine 60. The data generation model 58 and/or the interactive search engine 60 may be used by each unit that performs specific processing. At least one of the data generation model 58 and/or the interactive search engine 60 may be provided in an external system such as a cloud server accessible via the network 54.

The data generation model 58 may be an example of generative artificial intelligence (AI) used for facility management of the building. Examples of the generative AI include ChatGPT (a registered trademark of OpenAI, Inc. of San Francisco, CA) and Gemini (a registered trademark of Microsoft Corp. of Redmond, WA), and/or a generative AI tool that can be instructed in a natural language based on large language models (LLMs) can be used. The data generation model 58 may be obtained by causing a neural network to perform deep learning. To the data generation model 58, a prompt including an instruction may be input, and inference data such as voice data indicating a voice, text data indicating a text, and/or image data indicating an image may be input. The data generation model 58 may infer the input inference data according to the instruction indicated by the prompt, and may output an inference result in a data format such as voice data and/or text data. Here, the inference may refer to, for example, analysis, classification, prediction, and/or summary.

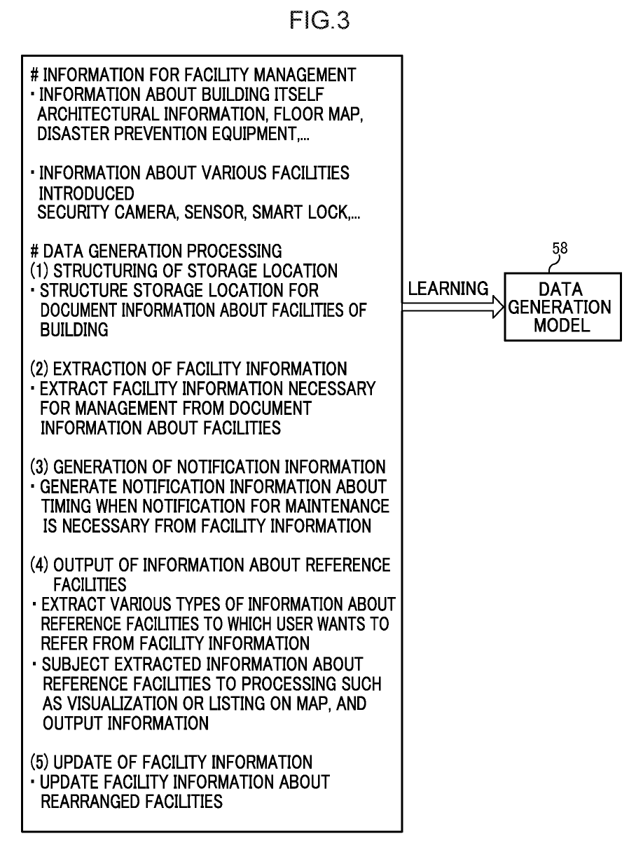

As illustrated in FIG. 3, the data generation model 58 according to the present example may be a model trained in advance using information for facility management of the building. The information for facility management may include information about the building itself and information about various facilities introduced. For example, the information about the building itself might include architectural information including the number of floors and an internal structure of the building, a floor map, and/or information about disaster prevention equipment. The information about various facilities may comprise a list of facilities introduced into the building, and may include information on facility names, the number of facilities, providers, and/or the like. By learning using these types of information for facility management, the data generation model 58 may be a model reflecting the features of the building. Note that the information about the building itself and/or the information about various facilities may be extracted by collecting existing documents about the building and the facilities.

In addition, the data generation model 58 may learn data generation processing including one or more of the following (1) to (5): (1) structuring of storage location, (2) extraction of facility information, (3) generation of notification information, (4) output of information about reference facilities, and/or (5) update of facility information. These data generation processing aspects will be described in terms of the respective functional configurations of specific processing, which will be described later.

The interactive search engine 60 may compriseAI that responds to an input by performing a search using an existing search engine in an interactive manner. Through the interaction, an operation for acquiring information about reference facilities for the building can be performed.

Next, functional configurations for performing the specific processing of the data processing device 12 will be described.

The structuring unit 290 may input information for facility management of the building into the data generation model 58, and may structure and create a storage location for storing document information. Specifically, the structuring of the storage location by the structuring unit 290 may cause the data generation model 58 to structure the storage location by inputting, into the data generation model 58, a first prompt for instructing the data generation model 58 to structure a directory, which is a storage location, using the information for facility management of the building. An instruction sentence may be created so as to use at least one of a floor level of the building, a floor configuration, a facility type, a provider type, and/or a document type as the information for facility management of the building. The process of structuring the storage location by the structuring unit 290 may be performed with reference to the information for facility management of the building described above, and may be executed by creating or updating the storage location using the facility information extracted by the extraction processing unit 292 when new document information is input by a vendor.

An example of a first prompt for structuring the storage location will be described.

An example of an instruction sentence in the first prompt: “The attached information is information for facility management of the building (information about the building itself and information about various facilities introduced). Please structure the directory for the storage location so that documents can be stored in a format that facilitates the management of the building ...”

In addition, the first prompt is not limited to that described above, and an instruction sentence for outputting a directory map in which a tree structure of a directory is visualized, or an instruction sentence for specifying floors or facilities to be managed collectively may be added. The structuring of the storage location described herein does not necessarily mean limiting the structure to a tree structure in a unique format. That is, in the conventional folder management format, once a hierarchical structure is created for each floor or in units of dates, it may be difficult to replace the structure in certain circumstances. Therefore, in the structuring of the present method, the structure might make it relatively easier to access and extract the following information without depending only on a specific format such as a floor and a date and time. For example, the structure might make it relatively easier to access and extract information about a device installed on a specific day, a device delivered by a specific vendor, and/or a device installed on a specific floor. Therefore, a database for distributing, extracting, and associating information might also be structured. When document information is stored, data may be automatically distributed, extracted, and/or associated according to the structured database, and then may be stored in the storage location.

The extraction processing unit 292 may input document information about facilities of the building into the data generation model 58, may extract facility information about facilities, and/or may store the document information in the storage location structured to correspond to the building. The document information may be input from vendors from which the facilities are provided. The document information itself may be delivered in various file formats depending on vendors and facilities, for example, a manual in a PDF or Word file, a plot drawing in CAD data, an equipment list in a spreadsheet, and/or the like. Therefore, it may be necessary to extract information required for management. Specifically, the extraction processing of the extraction processing unit 292 may cause the data generation model 58 to extract facility information by inputting, into the data generation model 58, a second prompt for instructing the data generation model 58 to extract information about facilities from the document information. At least an arrangement, types, handling specifications, maintenance-related specifications, and introduction dates of the facilities installed in the building may be extracted as the information about facilities. The maintenance-related specifications may include a battery replacement method, a replacement method in case of failure or damage, and/or the like. Furthermore, a document information storage destination may be output in addition to the specification information with reference to the directory structure. Note that the document information and/or the facility information may be stored in the same storage location in association with each other, and/or may be stored in different storage locations while holding a reference relationship. Additionally and/or alternatively, when information necessary for managing the facilities is not included in the document information and is insufficient, a request for information may be automatically notified to the vendors as providers.

An example of a second prompt for extracting facility information will be described.

An example of an instruction sentence in the second prompt: “The attached information is document information about newly introduced facilities. Please extract facility information necessary for management and maintenance of the facilities. Please extract at least an arrangement, types, handling specifications, maintenance-related specifications, and introduction dates of the facilities installed in the building as the facility information. Furthermore, please output a document information storage destination with reference to the directory structure ...”

Additionally and/or alternatively, the second prompt need not be limited to that described above, and an instruction sentence for listing facilities on the same floor or in the same type or an instruction sentence for updating the structure of the directory based on the extracted facility information may be added.

The update management unit 294 may input the extracted facility information into the data generation model 58, and may generate notification information for performing notification regarding the facilities. Additionally and/or alternatively, the update management unit 294 may manage execution of notification according to the generated notification information. For example, the update management unit 294 may generate notification information by inputting, into the data generation model 58, a third prompt for instructing the data generation model 58 to extract times when notification for maintenance is required for the facilities with reference to the maintenance-related specifications and the introduction dates included in the facility information.

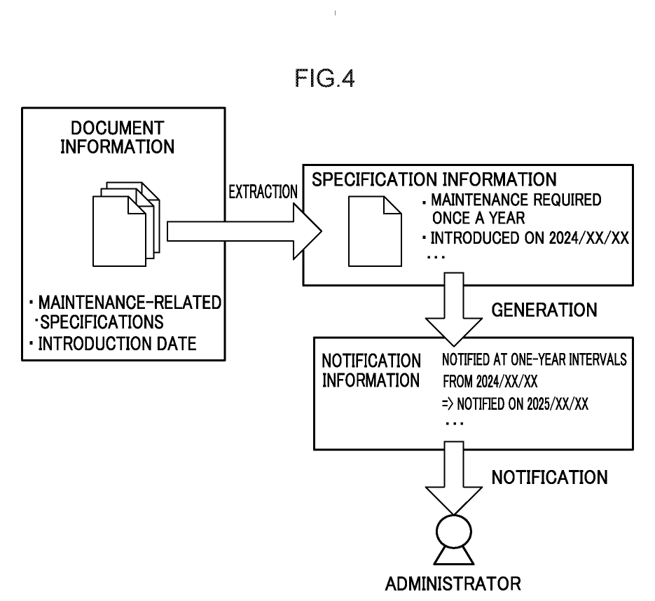

FIG. 4 is a diagram illustrating an example of notification management for the facilities based on the generated notification information. As illustrated in FIG. 4, in the generation of the notification information, for example, in a case where it is determined in the extracted specification information that the facilities require maintenance once a year, the notification information may be set at one-year intervals from that introduction date as a time when notification is required based on the introduction date.

An example of a third prompt for generating notification information will be described.

An example of an instruction sentence in the third prompt: “The attached information is extracted facility information. Please set times when notification is required with reference to the time when maintenance is required for the facilities and the introduction dates ...”

Additionally and/or alternatively, the third prompt need not be limited to that described above, and an instruction sentence for listing facilities for which notification may be required at the same time or an instruction sentence for listing notification times for facilities in the same type or on the same floor may be added with reference to notification information that has already been generated for other facilities.

The information management unit 296 may receive an operation for requesting acquisition of information about reference facilities to be referred to from the smart device 14 operated by the user. The information management unit 296 may input a fourth prompt corresponding to the request made by the operation into the data generation model 58, and may cause the data generation model 58 to output information about reference facilities corresponding to the operation. The output information about reference facilities may be stored in the RAM 30 as a primary storage destination, and may be kept in a state in which the user can refer to the information from the smart device 14. The information management unit 296 may output the information about reference facilities output from the data generation model 58 to the display 40A of the smart device 14. The request made by the operation may be to output any of map information indicating an arrangement of the reference facilities in the building, handling specifications of the reference facilities, list information about related facilities related to the reference facilities, and the like.

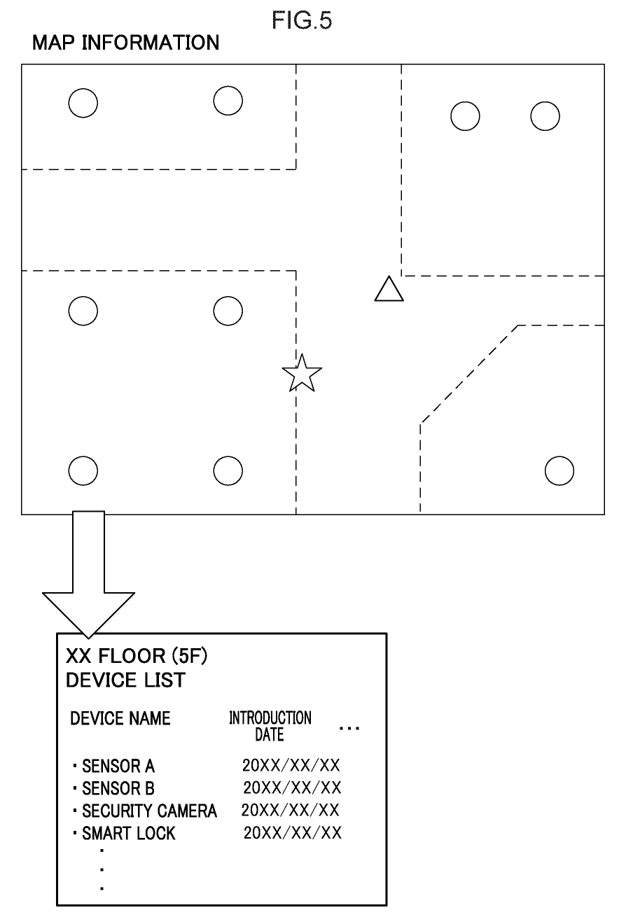

FIG. 5 is a diagram illustrating an example of map information and list information about related facilities. In the map information, a mark representing a reference facility may be attached to a location where the facility is disposed on the floor. The device list (list information) may display a list of facilities installed on the floor together with reference information such as introduction dates. The map information and the device list may be displayed in parallel, in a switching manner, or the like. In addition, the map information and the list information need not be limited to one floor, and map information and list information about facilities on a plurality of floors may be collectively output.

An example of a fourth prompt for outputting information about reference facilities will be described.

An example of an instruction sentence in the fourth prompt: “The user has requested the output of reference facilities. The content of the request is outputting an arrangement of reference facilities on XX floor and a device list. Please plot reference facilities on the map of XX floor, and output a device list ...”

Additionally and/or alternatively, the fourth prompt need not be limited to that described above, and an instruction sentence for adding a scheduled notification date of notification information, an instruction sentence for adding links capable of referring to handling specifications of the facilities to the device list, an instruction sentence for adding, to the device list, links to contact information of the vendors as providers or to document information, and the like may be added.

Next, the update of the facility information by the update management unit 294 will be described. The update management unit 294 may acquire rearrangement information about a plurality of rearranged facilities. The rearrangement information may be acquired from vendor’s work report emails and notifications of document information updates or the like, it may list and acquire a plurality of rearranged facilities. The update management unit 294 may input a fifth prompt including an instruction sentence for updating the facility information from the rearrangement information into the data generation model 58, and may update the facility information corresponding to each of the plurality of rearranged facilities to reflect the position of the rearranged facility.

An example of a fifth prompt for updating the facility information will be described. An example of an instruction sentence in the fifth prompt: “The following facilities have been rearranged. Please update the facility information to reflect the positions of the rearranged facilities ...” Additionally and/or alternatively, the fifth prompt is not limited to that described above, an instruction sentence for listing rearranged facilities or an instruction sentence for outputting map information including rearranged facilities may be added.

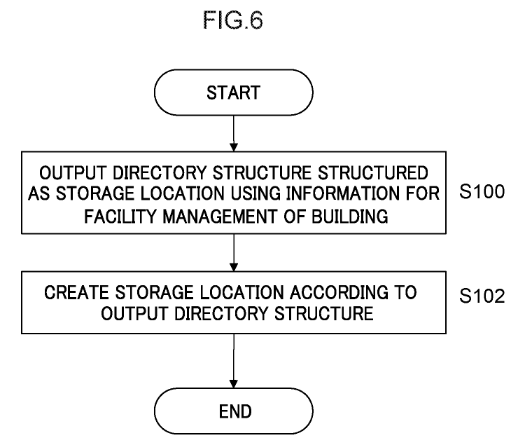

Next, the operation of the data processing system 10 will be described. An example of a flow of specific processing will be described with reference to FIG. 6 to FIG. 9. The flow of the specific processing illustrated in FIG. 6 to FIG. 9 is an example of a data processing method according to the technology of the present disclosure.

FIG. 6 is a flowchart of storage location structuring processing.

In step S100, the structuring unit 290 may input, into the data generation model 58, a first prompt for instructing the data generation model 58 to structure a directory, which may be a storage location, using the information for facility management of the building, and may output a directory structure structured as a storage location.

In step S102, the structuring unit 290 may create a storage location for managing the facilities of the building in the storage 32 according to the output directory structure.

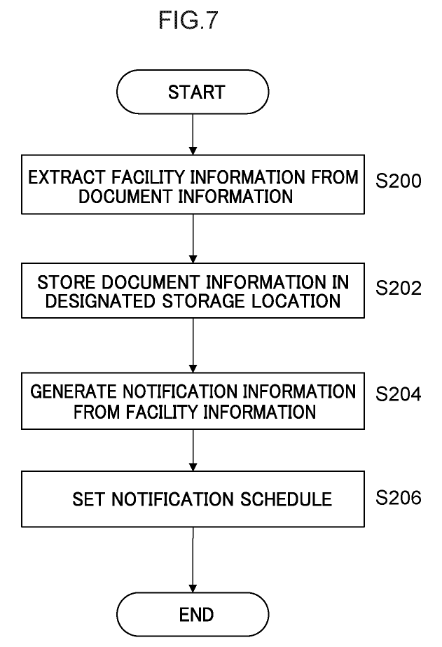

FIG. 7 is a flowchart of extraction of facility information and generation of notification information.

In step S200, the extraction processing unit 292 may input, into the data generation model 58, a second prompt for instructing the data generation model 58 to extract information about facilities from the document information, and may extract facility information about facilities.

In step S202, the extraction processing unit 292 may store the document information in a designated storage location of the directory structured to correspond to the building.

In step S204, the update management unit 294 may input, into the data generation model 58, a third prompt for instructing the data generation model 58 to extract times when notification for maintenance may be required for the facilities from the extracted facility information, and may generate notification information for performing notification regarding the facilities.

In step S206, a notification schedule may be set such that the notification is executed according to the generated notification information.

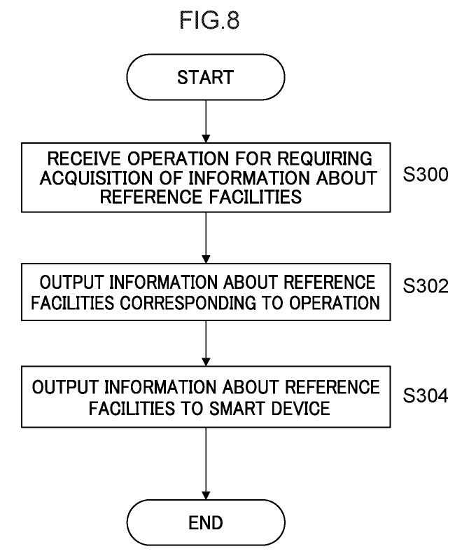

FIG. 8 is a flowchart of output of information about reference facilities.

In step S300, the information management unit 296 may receive an operation for requesting acquisition of information about reference facilities to be referred to from the smart device 14 operated by the user.

In step S302, the information management unit 296 may input a fourth prompt corresponding to the request made by the operation into the data generation model 58, and may cause the data generation model 58 to output and store information about reference facilities corresponding to the operation.

In step S304, the information management unit 296 may output the output information about reference facilities corresponding to the operation to the display of the smart device 14.

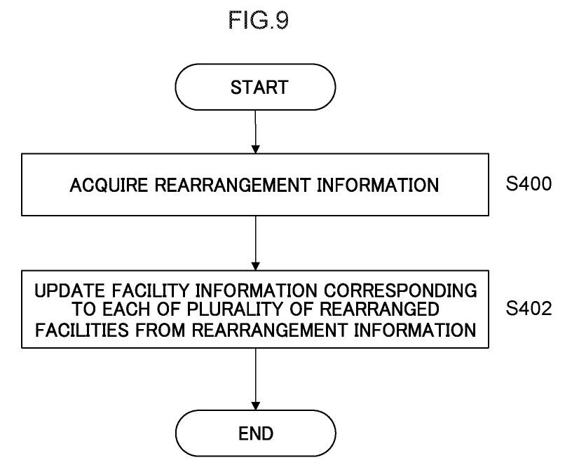

FIG. 9 is a flowchart of update of the facility information.

In step S400, the update management unit 294 may acquire rearrangement information about a plurality of rearranged facilities.

In step S402, the update management unit 294 may input a fifth prompt including, for example, an instruction sentence for updating the facility information from the rearrangement information into the data generation model 58, and/or may update the facility information corresponding to each of the plurality of rearranged facilities.

Although the system according to the present disclosure has been described above mainly in terms of the functions of the data processing device 12, the system according to the present disclosure is not necessarily implemented on a server. The system according to the present disclosure may be implemented as a general information processing system, such as on a computing device comprising one or more processors and memory storing instructions that, when executed by the one or more processors, perform one or more steps (such as any of the steps described above). The present disclosure may additionally and/or alternatively be implemented as, for example, a software program operating on a personal computer or an application operating on a smartphone or the like. The method according to the present disclosure may additionally and/or alternatively be provided to a user in a software as a service (SaaS) format.

In each of the above-described examples, the specific processing may be performed by one computer 22, but the technology of the present disclosure need not be limited thereto, and the specific processing may be performed by a plurality of computers including the computer 22 in a distributed manner. Furthermore, the specific processing and the avatar generation processing may be executed by different computers.

In the above-described example, the data processing program 56 may be stored in the storage 32, but the technology of the present disclosure need not be limited thereto. For example, the data processing program 56 may be stored in a portable computer-readable non-transitory storage medium such as a universal serial bus (USB) memory. The data processing program 56 stored in the non-transitory storage medium may be installed in the computer 22 of the data processing device 12. The processor 28 may execute specific processing according to the data processing program 56.

In addition, the data processing program 56 may be stored in a storage device such as a server connected to the data processing device 12 via the network 54, and the data processing program 56 may be downloaded and installed in the computer 22 (such as in response to a request from the data processing device 12).

Additionally and/or alternatively, it might not be necessary to store all of the data processing program 56 in a storage device such as a server connected to the data processing device 12 via the network 54 and/or to store all of the data processing program 56 in the storage 32, and a part of the data processing program 56 may be stored.

The data processing program 56 can be provided as a program product. The program product may include any type of product for providing a program. Examples of the program product may include a program provided through a network such as the Internet and a non-transitory computer-readable recording medium such as a CD-ROM or a DVD storing the program.

The following various processors can be used as hardware resources that execute the specific processing. Examples of the processors include a CPU, which is a general-purpose processor functioning as a hardware resource that executes the specific processing by executing software, that is, a program. In addition, examples of the processors include a dedicated electric circuit, which is a processor having a circuit configuration exclusively designed for executing the specific processing, such as a field-programmable gate array (FPGA), a programmable logic device (PLD), or an application specific integrated circuit (ASIC). A memory may be built in or connected to any processor, and any processor may execute specific processing by, for example, using the memory.

The hardware resource that executes the specific processing may be configured by one of these various processors, and/or may be configured by a combination of two or more processors of the same type or different types (e.g., a combination of a plurality of FPGAs or a combination of a CPU and an FPGA). The hardware resource that executes the specific processing may be one processor.

As an example in which the hardware resource that executes the specific processing is configured by one processor, first, there may be a mode in which one processor is configured by a combination of one or more CPUs and software, and this processor may function as a hardware resource that executes specific processing. Second, as represented by a system-on-a-chip (SoC) or the like, there may be a mode in which a processor that realizes the functions of the entire system including a plurality of hardware resources that execute the specific processing on one IC chip may be used. In this manner, the specific processing may be realized by using one or more of the above-described various processors as hardware resources.

Furthermore, more specifically, an electric circuit in which circuit elements such as semiconductor elements are combined can be used as a hardware structure for these various processors. In addition, the above-described specific processing is merely an example. Therefore, unnecessary steps may be deleted, new steps may be added, and/or the processing order may be changed without departing from the gist.

The above-described and illustrated contents are detailed descriptions of parts according to the technology of the present disclosure, and are merely examples of the technology of the present disclosure. For example, the above descriptions regarding configurations, functions, operations, and effects are descriptions regarding examples of configurations, functions, operations, and effects of parts according to the technology of the present disclosure. Therefore, unnecessary parts may be deleted, new parts may be added, and/or some parts may be replaced with respect to the above-described and illustrated contents without departing from the gist of the technology of the present disclosure. Furthermore, in order to avoid complication and to facilitate understanding of parts according to the technology of the present disclosure, in the above-described and illustrated contents, descriptions regarding common technical knowledge and the like that do not require any particular description to enable the implementation of the technology of the present disclosure are omitted.

All the documents, patent applications, and technical standards described in the present specification are incorporated herein by reference to the same extent as if each document, patent application, and technical standard were specifically and individually indicated to be incorporated by reference.

With regard to the above-described examples, the following supplementary notes are further disclosed.

(Supplementary Note 1) A data processing device including: a structuring unit configured to input information for facility management of a building into generative AI to structure a storage location for document information about facilities of the building; an extraction processing unit configured to input the document information into the generative AI to extract facility information about the facilities and store the document information in the structured storage location; and an update management unit configured to input the facility information into the generative AI to generate notification information for performing notification regarding the facilities and manage execution of notification according to the notification information.

(Supplementary Note 2) The data processing device according to supplementary note 1, in which the structuring unit causes the generative AI to structure the storage location by inputting, into the generative AI, a first prompt for instructing the generative AI to structure a directory as the storage location using at least one of a floor level of the building, a floor configuration, a facility type, a provider type, and a document type from the information for facility management of the building.

(Supplementary Note 3) The data processing device according to supplementary note 1, in which the extraction processing unit causes the generative AI to extract the facility information by inputting, into the generative AI, a second prompt for instructing the generative AI to extract at least an arrangement, types, handling specifications, maintenance-related specifications, and introduction dates of the facilities installed in the building as the information about facilities from the document information.

(Supplementary Note 4) The data processing device according to supplementary note 3, in which the update management unit causes the generative AI to generate the notification information by inputting, into the generative AI, a third prompt for instructing the generative AI to extract times when notification for maintenance is required for the facilities with reference to the maintenance-related specifications and the introduction dates included in the facility information.

(Supplementary Note 5) The data processing device according to any one of supplementary notes 1 to 4, further including: an information management unit, in which the information management unit receives an operation for requesting acquisition of information about reference facilities to be referred to from a user, and inputs a fourth prompt corresponding to the request made by the operation into the generative AI to cause the generative AI to output at least one of map information indicating an arrangement of the reference facilities in the building, handling specifications of the reference facilities, and list information about related facilities related to the reference facilities.

(Supplementary Note 6) The data processing device according to any one of supplementary notes 1 to 5, in which the update management unit lists a plurality of rearranged facilities, and inputs a fifth prompt including an instruction sentence for updating the facility information into the generative AI to update the facility information corresponding to each of the plurality of rearranged facilities to reflect a position of the rearranged facility.

(Supplementary Note 7) A data processing method executed by a computer, the data processing method including: inputting information for facility management of a building into generative AI to structure a storage location for document information about facilities of the building; inputting the document information into the generative AI to extract facility information about the facilities and store the document information in the structured storage location; and inputting the facility information into the generative AI to generate notification information for performing notification regarding the facilities and manage execution of notification according to the notification information.

(Supplementary Note 8) A program for causing a computer to execute: inputting information for facility management of a building into generative AI to structure a storage location for document information about facilities of the building; inputting the document information into the generative AI to extract facility information about the facilities and store the document information in the structured storage location; and inputting the facility information into the generative AI to generate notification information for performing notification regarding the facilities and manage execution of notification according to the notification information.

(Supplementary Note 9) A method comprising providing, as input to a generative AI, information for facility management of a building; determining, based on first output from the generative AI, a structure of a storage location for document information about facilities of the building; providing, as input to the generative AI, the document information; based on second output from the generative AI: extracting facility information about the facilities, and storing the document information in the storage location; providing, as input to the generative AI, the facility information; and based on third output from the generative AI: generating notification information for performing a notification regarding the facilities; and causing, based on the notification, execution of the notification.

(Supplementary Note 10) The method as described in Supplementary Note 9, wherein the providing the information for facility management of a building comprises: inputting, into the generative AI, a first prompt instructing the generative AI to structure a directory as the storage location based on at least one of a floor level of the building, a floor configuration, a facility type, a provider type, or a document type from the information for facility management of the building.

(Supplementary Note 11) The method as described in Supplementary Note 9 or 10, wherein the providing, as input to the generative AI, the document information comprises: inputting, into the generative AI, a second prompt instructing the generative AI to extract, from the documentation information, one or more of an arrangement, types, handling specifications, maintenance-related specifications, and introduction dates of the facilities installed in the building.

(Supplementary Note 12) The method as described in any one of Supplementary Notes 9-11, wherein the generating the notification information comprises: inputting, into the generative AI, a third prompt for instructing the generative AI to extract one or more of: times when notification for maintenance is required for the facilities with reference to the maintenance-related specifications, or the introduction dates included in the facility information.

(Supplementary Note 13) The method as described in any one of Supplementary Notes 9-12, further comprising: receiving a request for information about reference facilities to be referred to from a user; and providing, as input to the generative AI, a fourth prompt corresponding to the request; and receiving, as fourth output from the generative AI, at least one of map information indicating an arrangement of the reference facilities in the building, handling specifications of the reference facilities, or list information about related facilities related to the reference facilities.

(Supplementary Note 14) The method as described in any one of Supplementary Notes 9-13, further comprising: listing a plurality of rearranged facilities; providing, as input to the generative AI, a fifth prompt including an instruction sentence for updating the facility information; and updating, based on fourth output from the generative AI, the facility information corresponding to each of the plurality of rearranged facilities to reflect a position of the rearranged facility.

(Supplementary Note 15) The method as described in any one of Supplementary Notes 9-13, wherein the generative AI comprises a Large Language Model (LLM).

Any of the above devices and/or methods may be implemented in different forms. For example, a method may be implemented via a data processing device comprising one or more processors and memory storing instructions that, when executed by the one or more processors, cause performance of one or more steps of the method. As another example, steps performed by a computing device may instead be described as a method. Any such steps may additionally and/or alternatively be performed by one or more non-transitory computer-readable media and/or a system comprising one or more different devices.

What is claimed is:

1. A data processing device comprising:
one or more processors, and
memory storing instructions that, when executed by the one or more processors, cause the data processing device to:
provide, as input to a generative AI, information for facility management of a building ;
determine, based on first output from the generative AI, a structure of a storage location for document information about facilities of the building;
provide, as input to the generative AI, the document information;
based on second output from the generative AI:
extract facility information about the facilities, and
store the document information in the storage location;
provide, as input to the generative AI, the facility information ; and
based on third output from the generative AI:
generate notification information for performing a notification regarding the facilities; and
cause, based on the notification, execution of the notification.

2. The data processing device according to claim 1, wherein the instructions, when executed by the one or more processors, further cause the data processing device to provide the information for facility management of a building by causing the data processing device to:
input, into the generative AI, a first prompt instructing the generative AI to structure a directory as the storage location based on at least one of a floor level of the building, a floor configuration, a facility type, a provider type, or a document type from the information for facility management of the building.

3. The data processing device according to claim 1, wherein the instructions, when executed by the one or more processors, cause the data processing device to provide, as input to the generative AI, the document information by causing the data processing device to:
input, into the generative AI, a second prompt instructing the generative AI to extract, from the documentation information, one or more of an arrangement, types, handling specifications, maintenance-related specifications, and introduction dates of the facilities installed in the building.

4. The data processing device according to claim 3, wherein the instructions, when executed by the one or more processors, cause the data processing device to generate the notification information by causing the data processing device to:
input, into the generative AI, a third prompt for instructing the generative AI to extract one or more of:
times when notification for maintenance is required for the facilities with reference to the maintenance-related specifications, or
the introduction dates included in the facility information.

5. The data processing device according to claim 1, wherein the instructions, when executed by the one or more processors, further cause the data processing device to:
receive a request for information about reference facilities to be referred to from a user; and
provide, as input to the generative AI, a fourth prompt corresponding to the request ; and
receive, as fourth output from the generative AI, at least one of map information indicating an arrangement of the reference facilities in the building, handling specifications of the reference facilities, or list information about related facilities related to the reference facilities.

6. The data processing device according to claim 1, wherein the instructions, when executed by the one or more processors, further cause the data processing device to:
list a plurality of rearranged facilities;
provide, as input to the generative AI, a fifth prompt including an instruction sentence for updating the facility information ; and
update, based on fourth output from the generative AI, the facility information corresponding to each of the plurality of rearranged facilities to reflect a position of the rearranged facility.

7. The data processing device of claim 1, wherein the generative AI comprises a Large Language Model (LLM).

8. A method comprising:
providing, as input to a generative AI, information for facility management of a building;
determining, based on first output from the generative AI, a structure of a storage location for document information about facilities of the building;
providing, as input to the generative AI, the document information;
based on second output from the generative AI:
extracting facility information about the facilities, and
storing the document information in the storage location;
providing, as input to the generative AI, the facility information; and
based on third output from the generative AI:
generating notification information for performing a notification regarding the facilities; and
causing, based on the notification, execution of the notification.

9. The method of claim 8, wherein the providing the information for facility management of a building comprises:
inputting, into the generative AI, a first prompt instructing the generative AI to structure a directory as the storage location based on at least one of a floor level of the building, a floor configuration, a facility type, a provider type, or a document type from the information for facility management of the building.

10. The method of claim 8, wherein the providing, as input to the generative AI, the document information comprises:
inputting, into the generative AI, a second prompt instructing the generative AI to extract, from the documentation information, one or more of an arrangement, types, handling specifications, maintenance-related specifications, and introduction dates of the facilities installed in the building.

11. The method of claim 8, wherein the generating the notification information comprises:
inputting, into the generative AI, a third prompt for instructing the generative AI to extract one or more of:
times when notification for maintenance is required for the facilities with reference to the maintenance-related specifications, or
the introduction dates included in the facility information.

12. The method of claim 8, further comprising:
receiving a request for information about reference facilities to be referred to from a user; and
providing, as input to the generative AI, a fourth prompt corresponding to the request; and
receiving, as fourth output from the generative AI, at least one of map information indicating an arrangement of the reference facilities in the building, handling specifications of the reference facilities, or list information about related facilities related to the reference facilities.

13. The method of claim 8, further comprising:
listing a plurality of rearranged facilities;
providing, as input to the generative AI, a fifth prompt including an instruction sentence for updating the facility information; and
updating, based on fourth output from the generative AI, the facility information corresponding to each of the plurality of rearranged facilities to reflect a position of the rearranged facility.

14. The method of claim 8, wherein the generative AI comprises a Large Language Model (LLM).

15. One or more non-transitory computer-readable media storing instructions that, when executed by one or more processors of a data processing device, cause the data processing device to:
provide, as input to a generative AI, information for facility management of a building;
determine, based on first output from the generative AI, a structure of a storage location for document information about facilities of the building;
provide, as input to the generative AI, the document information;
based on second output from the generative AI:
extract facility information about the facilities, and
store the document information in the storage location;
provide, as input to the generative AI, the facility information; and
based on third output from the generative AI:
generate notification information for performing a notification regarding the facilities; and
cause, based on the notification, execution of the notification.

16. The one or more non-transitory computer-readable media of claim 15, wherein the instructions, when executed by the one or more processors, further cause the data processing device to provide the information for facility management of a building by causing the data processing device to:
input, into the generative AI, a first prompt instructing the generative AI to structure a directory as the storage location based on at least one of a floor level of the building, a floor configuration, a facility type, a provider type, or a document type from the information for facility management of the building.

17. The one or more non-transitory computer-readable media of claim 15, wherein the instructions, when executed by the one or more processors, cause the data processing device to provide, as input to the generative AI, the document information by causing the data processing device to:
input, into the generative AI, a second prompt instructing the generative AI to extract, from the documentation information, one or more of an arrangement, types, handling specifications, maintenance-related specifications, and introduction dates of the facilities installed in the building.

18. The one or more non-transitory computer-readable media of claim 17, wherein the instructions, when executed by the one or more processors, cause the data processing device to generate the notification information by causing the data processing device to:
input, into the generative AI, a third prompt for instructing the generative AI to extract one or more of:
times when notification for maintenance is required for the facilities with reference to the maintenance-related specifications, or
the introduction dates included in the facility information.

19. The one or more non-transitory computer-readable media of claim 15, wherein the instructions, when executed by the one or more processors, further cause the data processing device to:
receive a request for information about reference facilities to be referred to from a user; and
provide, as input to the generative AI, a fourth prompt corresponding to the request; and
receive, as fourth output from the generative AI, at least one of map information indicating an arrangement of the reference facilities in the building, handling specifications of the reference facilities, or list information about related facilities related to the reference facilities.

20. The one or more non-transitory computer-readable media of claim 15, wherein the instructions, when executed by the one or more processors, further cause the data processing device to:
list a plurality of rearranged facilities;
provide, as input to the generative AI, a fifth prompt including an instruction sentence for updating the facility information; and
update, based on fourth output from the generative AI, the facility information corresponding to each of the plurality of rearranged facilities to reflect a position of the rearranged facility.
